(19) United States
(12) Patent Application Publication
(10) Pub. No.: US 2011/0008746 A1
(43) Pub. Date: Jan. 13, 2011

(54) APPARATUS OF LIQUID INJECTING FOR LIFTING MAXILLARY SINUS MUCOUS MEMBRANCE AND THE METHOD FOR THE SAME UTILIZING THIS APPARATUS

(76) Inventor: Dae Yuen Kim, Incheon (KR)

Correspondence Address: PARK LAW FIRM, 3255 WILSHIRE BLVD, SUITE 1110, LOS ANGELES, CA, 90010, US

(21) Appl. No.: 12/918,180

(22) PCT Filed: Dec. 31, 2008
(86) PCT No.: PCT/KR08/07891

§ 371 Date: Aug. 18, 2010

(30) Foreign Application Priority Data
Jan. 4, 2008 (KR) 10-2008-0001439
Dec. 24, 2008 (KR) 10-2008-0133404

(51) Int. Cl. A61C 19/00

(52) U.S. Cl. 433/25; 433/173

(57) ABSTRACT

A liquid injection apparatus for lifting a maxillary sinus mucous membrane includes a passageway longitudinally extending through inside the apparatus; a connecting pipe formed at a rear portion to connect with a liquid supply apparatus; and an injection pipe 16 formed in a front portion, for being inserted into an implant hole extending to a bottom of a mucous membrane of a maxillary sinus, with a distal end of the injection pipe 16 spaced apart from the mucous membrane by a predetermined distance. The injection pipe is structured to inject liquid into the implant hole while closing the implant hole. The liquid injection apparatus can more easily lift the maxillary sinus mucous membrane without damaging the same by applying uniform pressure to the maxillary sinus mucous membrane when the maxillary sinus mucous membrane is being lifted.

### TECHNICAL FIELD

The present invention relates to a liquid injection apparatus for lifting a maxillary sinus mucous membrane during a dental implant surgery and a method of lifting the maxillary sinus mucous membrane using the same apparatus, and more particularly, to a liquid injection apparatus for lifting a maxillary sinus mucous membrane and a method of lifting the maxillary sinus mucous membrane using the same apparatus, wherein the mucous membrane is lifted without any damage by evenly dispersing the hydraulic pressure on the mucous membrane while using this apparatus, thereby improving the reliability on the dental implant surgery.

### BACKGROUND ART

A dental implant is a cutting-edge surgical operation in which an artificial tooth root, made of titanium alloy not inducing any rejection by the human body, is replaced and integrated into an evacuated site of the alveolar bone instead of the evacuated tooth, and then a specially-designed artificial tooth is fixed on the artificial tooth root later on in order to recover the original function of the tooth. This dental implant is broadly performed these days since it semi-permanently replaces the function of the natural tooth with one procedure, without causing any damage to the dental structure.

However, it is reported that a success rate is comparatively lower in upper jawbone implant cases compared to other implant cases. A long implant cannot be embedded in the upper jawbone since the osseous tissue in the upper jawbone is soft and the bone thickness is too thin to support the implant owing to the maxillary sinus 20 located above as shown in FIG. 1.

Further, the maxillary sinus located above the upper jawbone is a hollow cavity surrounded by a thin mucous membrane and can be expanded by lowering the mucous membrane when the teeth are missing. Implant surgery is difficult to perform on this area since the bone thickness is too thin to embed the implant therein.

That is the reason why various proposals are recommended to perform the dental implant after securing enough supporting force in the upper jawbone area and major dental implant methods are classified into lateral approach maxillary sinus augmentation and osteotome maxillary sinus augmentation.

Among the aforementioned implant methods, the osteotome maxillary sinus augmentation is generally performed since its implant method and devices have been continuously developed. The implant method of the osteotome maxillary sinus augmentation will be described hereinafter.

First, using a twist drill, a pilot hole is formed to reach the compact bone just below the maxillary mucous membrane, while maintaining a safe distance of not contacting the maxillary mucous membrane.

Next, the hole is gradually enlarged by repeatedly tapping with other osteotomes having lager diameters until a hole of a proper size for an implant installation is achieved.

After breaking the compact bone by carefully tapping the osteotome, graft bone material is inserted into the implant hole.

The next step is to lift sinus membrane by softly tapping the hole already inserted with graft bone material again and securing a proper bone height of the hole so as to install the implant.

Finally, the procedure is finished by installing the implant after securing the aforementioned proper bone height.

During the above implant procedure, special care is required while lifting the maxillary sinus mucous membrane. The maxillary sinus mucous membrane is easily cut or damaged by a sharp edge. Such a cut or damage may cause a serious inflammation or necrosis, which may cause irreparable damage.

However, there have been many problems since the dental surgeon lifts the maxillary sinus mucous membrane by tapping the jawbone during the osteotome maxillary sinus augmentation. For example, an untrained dental surgeon may tap the jawbone with an excessive force and cause damage to the mucous membrane. Although a specialist with proper training and experience performs the dental implant depending only on his/her senses, there have been problems of inadvertently cutting or damaging the mucous membrane owing to slight carelessness.

To improve the aforementioned problems in the prior art, various maxillary sinus lifting methods have been proposed in order to prevent the maxillary sinus mucous membrane from being damaged during the implant surgery. Major medical treatments, for example, are a method of inserting a balloon into an implant hole and filling the balloon with the air so as to lift the mucous membrane by the inflated balloon or a method of injecting a fluid such as a saline solution with a syringe so as to lift the mucous membrane.

However, the aforementioned sinus lifting methods also did not provide a satisfactory effect to preserve the maxillary sinus mucous membrane.

The balloon method often causes damage to the mucous membrane since the inflated balloon mainly presses only the contacting area rather than the whole area, and the balloon skin often rubs and damages the mucous membrane while being inflated.

In the fluid-injecting method with a syringe, as shown in FIG. 2, a syringe 30 is inserted into an implant hole 24 formed below the mucous membrane 22 of the maxillary sinus 20 to inject a fluid such as a saline solution therein. Some of the fluids injected into the implant hole 24 drain away and the result is that the mucous membrane 22 is not smoothly lifted since enough pressure is not provided.

When the fluid injection pressure is increased in order to smoothly lift the mucous membrane 22, too much pressure can be focused on one spot where the fluid is injected, thereby causing damage such as necrosis on the mucous membrane 22.

### DISCLOSURE OF INVENTION

### Technical Problem

The present invention has been made to solve the foregoing problems which are occurring during lifting a maxillary sinus mucous membrane in the prior art, and embodiments of the present invention provide a liquid injection apparatus for lifting a maxillary sinus mucous membrane and a method of lifting the maxillary sinus mucous membrane using the same apparatus, wherein the sinus mucous membrane is smoothly lifted without any damage by equally spreading out hydraulic pressure on the mucous membrane.

### Technical Solution

Embodiments of the present provide a liquid injection apparatus for lifting a maxillary sinus mucous membrane, which includes a passageway longitudinally extending through inside the apparatus; a connecting pipe formed at a rear portion to connect with a liquid supply apparatus; and an injection pipe formed in a front portion, for being inserted into an implant hole extending to a bottom of a mucous membrane of a maxillary sinus, with a distal end of the injection pipe spaced apart from the mucous membrane by a predetermined distance. The injection pipe is structured to inject liquid into the implant hole while closing the implant hole. The liquid injection apparatus can more easily lift the maxillary sinus mucous membrane without damaging the same by applying uniform pressure to the maxillary sinus mucous membrane when the maxillary sinus mucous membrane is being lifted.

### Advantageous Effects

According to the present invention, the sinus lift can be smoothly performed without any damages on the mucous membrane by equally pressing the maxillary sinus mucous membrane using liquid.

### BRIEF DESCRIPTION OF DRAWINGS

FIG. 1 is a schematic view illustrating the location and the shape of maxillary sinuses;

FIG. 2 is a view illustrating a procedure of lifting a maxillary sinus mucous membrane using a liquid injection method according to the prior art;

FIG. 3 is a perspective view illustrating a liquid injection apparatus in accordance with the present invention;

FIG. 4 is a cross-sectional view of the liquid injection apparatus in accordance with the present invention;

FIG. 5 is a perspective view illustrating another embodiment of the liquid injection apparatus in accordance with the present invention;

FIG. 6 is an assembly view in which the liquid injection apparatus in accordance with the present invention is connected with a liquid supply apparatus;

FIG. 7 is a view illustrating a procedure of lifting a maxillary sinus mucous membrane using the liquid injection apparatus in accordance with the present invention;

FIG. 8 is a schematic view illustrating stages of lifting the maxillary sinus mucous membrane using another embodiment of the liquid injection apparatus in accordance with the present invention; and

FIG. 9 is a schematic view illustrating the state after the dental implant surgery in accordance with the present invention is carried out.

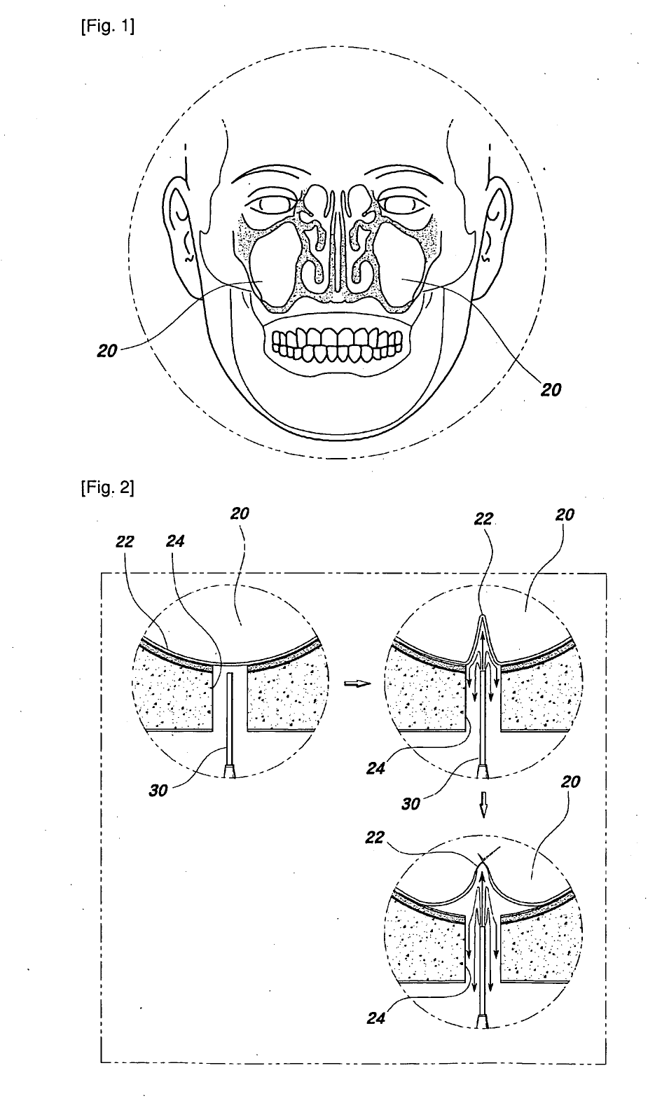

### MAJOR REFERENCE NUMERALS OF DRAWINGS

10: liquid injection apparatus

12: passageway 14: connecting pipe

16: injection pipe 17: supplementary outlet

20: maxillary sinus 22: mucous membrane

24: implant hole 30: syringe

50: liquid supply apparatus

### MODE FOR THE INVENTION

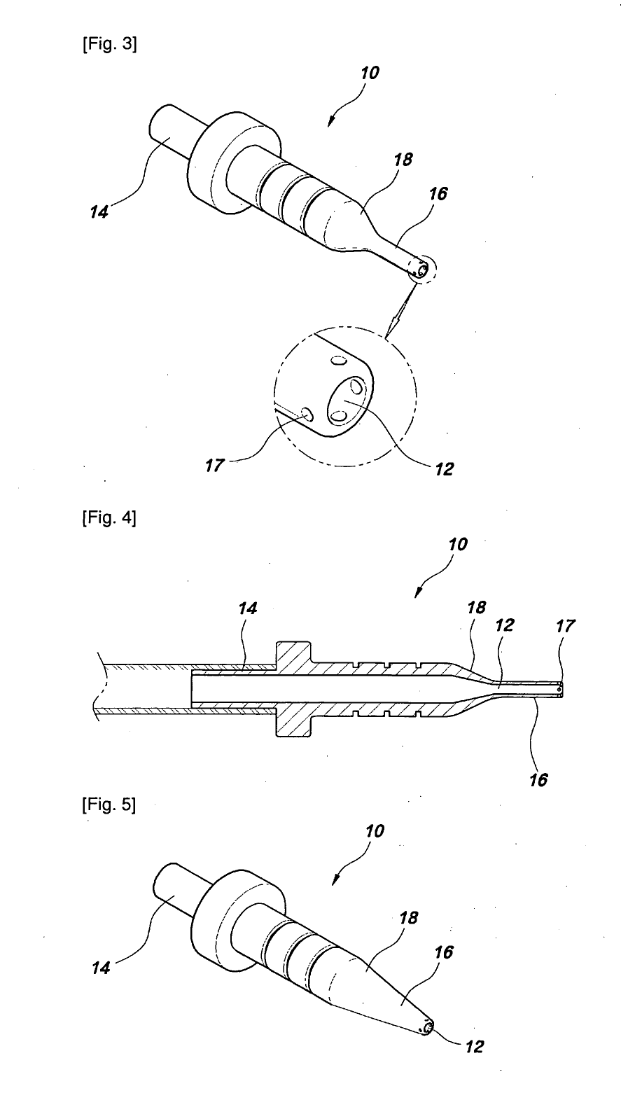

The present invention will be described more fully hereinafter referring to FIGS. 3 to 9.

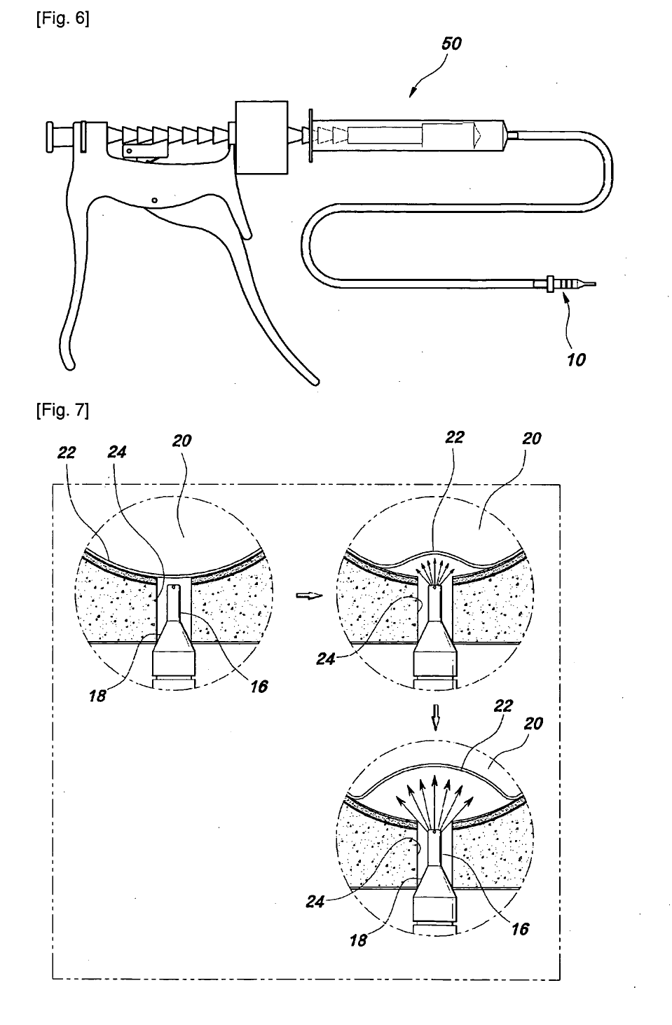

FIG. 3 is a perspective view illustrating a liquid injection apparatus in accordance with the present invention, FIG. 4 is a cross-sectional view of the liquid injection apparatus in accordance with the present invention, FIG. 5 is a perspective view illustrating another embodiment of the liquid injection apparatus in accordance with the present invention, and FIG. 6 is an assembly view in which the liquid injection apparatus in accordance with the present invention is connected with a liquid supply apparatus.

As shown in the figures, the liquid injection apparatus 10 in accordance with the present invention has a cylindrical body, and includes a passageway 12 longitudinally extending through the inside thereof to supply liquid, a connecting pipe 14 formed in the rear portion thereof to connect with a liquid supply apparatus 50, which is separately prepared, and an injection pipe 16 formed in the front portion thereof.

At the distal end, the injection pipe 16 is formed with supplementary outlets 17, which extend through from the passageway 12 to the outside. This structure can be selectively adopted and is formed to smoothly inject the liquid in various directions.

In the mean time, the injection pipe 16 can be structured in various forms. For example, a shoulder portion 18 can be formed to gradually increase the circumferential diameter to the rear portion as shown in FIG. 3. Alternatively, the injection pipe 16 can be formed to linearly increase the circumferential diameter to the rear portion as shown in FIG. 5.

In accordance with the aforementioned structure, the apparatus is constructed to allow the liquid supplied from the liquid supply apparatus 50 to travel along the passageway 12 and consequently be injected outwards via the injection pipe 16. Here, any means which can supply liquid can be used as the liquid supply apparatus 50. A device which manually injects the liquid or another type of device which can automatically inject the liquid for a certain period of time with the stable pressure can be selectively used.

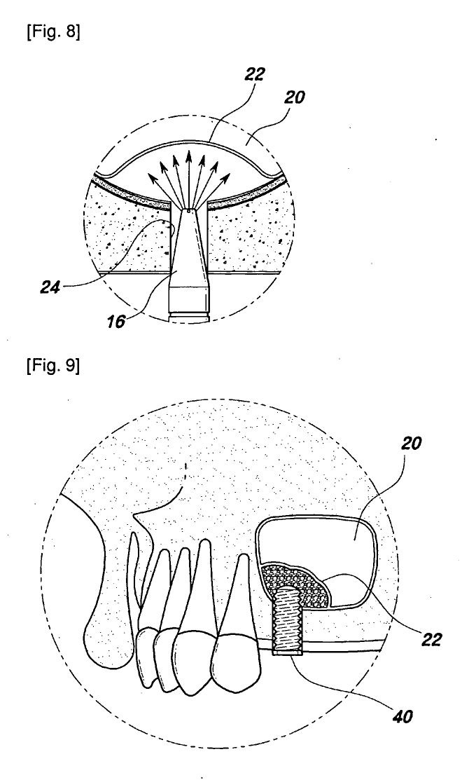

FIG. 7 is a view illustrating a procedure of lifting a maxillary sinus mucous membrane using the liquid injection apparatus in accordance with the present invention, FIG. 8 is a schematic view illustrating stages of lifting the maxillary sinus mucous membrane using another embodiment of the liquid injection apparatus in accordance with the present invention, and FIG. 9 is a schematic view illustrating the state after the dental implant surgery in accordance with the present invention is carried out.

The liquid injection apparatus 10 in accordance with the present invention can be used after an implant hole 24 is perforated to the bottom of the mucous membrane 22 of the maxillary sinus 20 with a boring means such as a drill (not shown). The edge of the injection pipe 16 is inserted into the implant hole 24, and then the liquid can be injected into the implant hole 24.

When inserting the injection pipe 16 into the implant hole 24, the distal end can be inserted with an interval spaced apart from the mucous membrane for a certain distance. The purpose is to prevent the distal end of the injection pipe 16 from stimulating and thus damaging the mucous membrane 22 through direct contact.

Once the injection pipe 16 is inserted into the implant hole 24, the shoulder portion 18 formed at the rear area of the injection pipe 16 is tightly fitted into the entrance of the implant hole 24 thereby closing the implant hole 24. The injection pipe 16, which is formed to gradually increase the circumferential diameter to the rear area in another embodiment of the present invention as shown in FIG. 8, is also tightly fitted into the implant hole 24 thereby closing the implant hole 24.

After the injection pipe 16 is inserted into and closes the implant hole 24, the liquid is supplied by the separately-prepared liquid supply apparatus 50. When the liquid reaches the injection pipe 16, the liquid is sprayed on the mucous membrane 22. At this time, the liquid is required to be sprayed very slowly since the mucous membrane 22 can be damaged when the liquid is spayed too forcefully.

The mucous membrane 22 is pressed by the liquid filling the implant hole 24 when the liquid is sprayed. After the implant hole 24 is fully filled with the liquid, the pressure on the mucous membrane 22 is evenly dispersed. The mucous membrane 22 is then safely lifted since the pressure is not focused on any specific spot.

Since the implant hole 24 is closed, the pressure on the liquid in a limited space is dispersed across the whole are without being reduced (Pascal's Principle). Therefore, the pressure of the liquid is uniformly dispersed across the whole area and thereby pushes up the whole surface of the mucous membrane with a uniform pressure. Consequently, smooth sinus lifting is possible without any damage to the mucous membrane 22.

After the maxillary sinus 20 mucous membrane 22 is fully lifted in the aforementioned procedure, the injection pipe 16 is removed from the implant hole 24 and the liquid having drained out from the implant hole 24 can be removed according to an adequate method.

The next step is to insert a bone graft taken from the patient or artificial bone little by little into the space secured by the lifted mucous membrane 22 using a well-known method. When the graft bone or artificial bone is properly stabilized after a certain period of time, an implant 40 is placed. Finally, the dental implant surgery is finished as shown in FIG. 9.

1. A liquid injection apparatus for lifting a maxillary sinus mucous membrane, comprising:
a passageway longitudinally extending through inside the apparatus;
a connecting pipe formed at a rear portion to connect with a liquid supply apparatus; and
an injection pipe formed in a front portion, for being inserted into an implant hole extending to a bottom of a mucous membrane of a maxillary sinus, with a distal end of the injection pipe spaced apart from the mucous membrane by a predetermined distance, wherein the injection pipe is structured to inject liquid into the implant hole while closing the implant hole.

2. The liquid injection apparatus for lifting a maxillary sinus mucous membrane according to claim 1, wherein the injection pipe has a shoulder portion gradually increasing a circumferential diameter to the rear portion, thereby closing the implant hole.

3. The liquid injection apparatus for lifting a maxillary sinus mucous membrane according to claim 1, wherein the injection pipe is structured to gradually increase a circumferential diameter to the rear portion, thereby closing the implant hole.

4. The liquid injection apparatus for lifting a maxillary sinus mucous membrane according to any one of claims 1 to 3, wherein the injection pipe has supplementary outlets formed in the distal end thereof, extending from the passageway to outside.

5. A method of lifting a maxillary sinus mucous membrane, comprising:
perforating an implant hole to a bottom of a mucous membrane of a maxillary sinus with a drill;
preparing a liquid injection apparatus as described according to any one of claims 1 to 4 and inserting the injection pipe of the liquid injection apparatus into the implant hole to close the implant hole; and
spraying liquid through the injection pipe using a separately-prepared liquid supply apparatus so that pressure is evenly dispersed on the mucous membrane thereby lifting the mucous membrane.

6. The method of lifting a maxillary sinus mucous membrane according to claim 5, wherein the distal end of the injection pipe is spaced apart for a certain distance from the mucous membrane.
